(19) United States
(12) Patent Application Publication
(10) Pub. No.: US 2021/0021663 A1
(43) Pub. Date: Jan. 21, 2021

(54) METHOD FOR PROCESSING NETWORK DATA, AND TERMINAL, SERVER AND STORAGE MEDIUM THEREOF

(71) Applicant: Beijing Dajia Internet Information Technology Co, Ltd., Beijing (CN)

(72) Inventors: Chi ZHOU, Beijing (CN); Yazhou SUN, Beijing (CN)

(21) Appl. No.: 16/931,093

(22) Filed: Jul. 16, 2020

(30) Foreign Application Priority Data
Jul. 16, 2019 (CN) 201910642282.8

(51) Int. Cl. H04L 29/06; H04N 21/2187; H04L 29/08

(52) U.S. Cl. CPC H04L 65/608; H04L 65/4069; H04L 67/306; H04L 65/1059; H04N 21/2187

(57) ABSTRACT

A method for processing network data, and a terminal, a server and a storage medium thereof are provided. The method includes: displaying a live streaming interface of a first user account logged on to the first terminal; in response to receiving a trigger instruction for the entrance, acquiring merged live streaming content and a question item; displaying the merged live streaming content and the question item on the live streaming interface; and displaying an answering result of the question item on the live streaming interface.

This application is based on and claims priority under 35 U.S.C. 119 to Chinese patent application No. 201910642282.8, filed on Jul. 16, 2019, in the China National Intellectual Property Administration, the disclosure of which is herein incorporated by reference in its entirety.

### TECHNICAL FIELD

The present disclosure relates to the field of computers, and in particular, relates to a method for processing network data, and a terminal, a server and a storage medium thereof.

### BACKGROUND

With the development of Internet, live video streaming has become a popular entertainment. In a scenario of live video streaming, an anchor is performing in a live streaming room, and audience can enter the live streaming room to watch and comment on the live streaming content of the anchor. This interaction in the live streaming is relatively monotonous, and how to increase the interactivity in the live streaming room is a problem worthy of concern.

### SUMMARY

The present disclosure provides a method for processing network data, and a terminal, a server and a storage medium thereof. Technical solutions of the present disclosure are described as below.

According to one aspect of embodiments of the present disclosure, a method for processing network data is provided. The method is applicable to a first terminal, and includes:

displaying a live streaming interface of a first user account logged on to the first terminal, the live streaming interface including an entrance for initiating answering;

in response to receiving a trigger instruction for the entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

According to one aspect of embodiments of the present disclosure, a method for processing network data is provided. The method is applicable to a server, and includes:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

According to one aspect of embodiments of the present disclosure, a terminal is provided. The terminal includes:

at least one processor; and

at least one memory configured to store at least one instruction executable by the at least one processor.

The at least one processor is configured to execute the at least one instruction to perform the following steps:

displaying a live streaming interface of a first user account logged on to the first terminal, the live streaming interface including an entrance for initiating answering;

in response to receiving a trigger instruction for an entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

According to one aspect of embodiments of the present disclosure, a server is provided. The server includes:

at least one processor; and

at least one memory configured to store at least one instruction executable by the at least one processor.

The at least one processor is configured to execute the at least one instruction to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

According to one aspect of embodiments of the present disclosure, a storage medium is provided. The storage medium stores at least one instruction therein. The at least one instruction, when executed by a processor of a terminal, enables the terminal to perform the following steps:

displaying a live streaming interface of a first user account logged on to the first terminal, the live streaming interface including an entrance for initiating answering;

in response to receiving a trigger instruction for the entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

According to one aspect of embodiments of the present disclosure, a storage medium is provided. The storage medium stores at least one instruction therein. The at least one instruction, when executed by a processor of a terminal, enables the terminal to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

According to one aspect of embodiments of the present disclosure, a computer program product is provided. The computer program stores at least one instruction therein.

The at least one instruction, when executed by a processor of a terminal, enables the terminal to perform the following steps:

displaying a live streaming interface of a first user account logged on to the first terminal, the live streaming interface including an entrance for initiating answering;

in response to receiving a trigger instruction for the entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

According to one aspect of embodiments of the present disclosure, a computer program product is provided. The computer program stores at least one instruction therein. The at least one instruction, when executed by a processor of a terminal, enables the terminal to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

It should be understood that the above general description and the following detailed description are merely exemplary and explanatory, and are not intended to limit the present disclosure.

### BRIEF DESCRIPTION OF DRAWINGS

The accompanying drawings herein, which are incorporated in and constitute part of the description, illustrate embodiments consistent with the present disclosure, serve to explain the principles of the present disclosure together with the description, and do not constitute an undue limitation to the present disclosure.

FIG. 1 is a schematic diagram of an implementing environment of a method for processing network data in accordance with an exemplary embodiment;

FIG. 2 is a block diagram of a terminal in accordance with an exemplary embodiment;

FIG. 3 is a block diagram of a server in accordance with an exemplary embodiment;

FIG. 4 is a flow chart of a method for processing network data in accordance with an exemplary embodiment;

FIG. 5 is a flow chart of a method for processing network data in accordance with an exemplary embodiment;

FIG. 6 is a flow chart of a method for processing network data in accordance with an exemplary embodiment;

FIG. 7 is a schematic diagram of a live streaming interface in accordance with an exemplary embodiment;

FIG. 8 is a schematic diagram of an interface of a live streaming application in accordance with an exemplary embodiment;

FIG. 9 is a schematic diagram of a live streaming interface in accordance with an exemplary embodiment;

FIG. 10 is a schematic diagram of a live streaming interface in accordance with an exemplary embodiment;

FIG. 11 is a schematic diagram of a live streaming interface in accordance with an exemplary embodiment;

FIG. 12 is a schematic diagram of a live streaming interface in accordance with an exemplary embodiment;

FIG. 13 is a schematic diagram of a live streaming interface in accordance with an exemplary embodiment;

FIG. 14 is a schematic diagram of a live streaming interface in accordance with an exemplary embodiment;

FIG. 15 is a schematic diagram of a live streaming interface in accordance with an exemplary embodiment;

FIG. 16 is a schematic diagram showing an information interface of a user account in accordance with an exemplary embodiment;

FIG. 17 is a schematic diagram of a ranking interface in accordance with an exemplary embodiment;

FIG. 18 is a schematic diagram of a virtual items exchange interface in accordance with an exemplary embodiment;

FIG. 19 is a schematic diagram showing an information interface of a user account in accordance with an exemplary embodiment;

FIG. 20 is a schematic diagram of a target interface in accordance with an exemplary embodiment;

FIG. 21 is a schematic diagram showing a live streaming process of answering in accordance with an exemplary embodiment;

FIG. 22 is a schematic diagram of TCP three-way handshake in accordance with an exemplary embodiment;

FIG. 23 is a schematic diagram of one-to-many signaling interaction in accordance with an exemplary embodiment;

FIG. 24 is a schematic diagram of a state machine in accordance with an exemplary embodiment;

FIG. 25 is a schematic diagram of end-counting in accordance with an exemplary embodiment;

FIG. 26 is a block diagram of an apparatus for processing network data in accordance with an exemplary embodiment; and

FIG. 27 is a block diagram of an apparatus for processing network data in accordance with an exemplary embodiment.

### DESCRIPTION OF EMBODIMENTS

For better understanding of the technical solutions of the present disclosure by persons of ordinary skill in the art, the technical solutions in the embodiments of the present disclosure are described hereinafter clearly and completely with reference to the accompanying drawings.

It should be noted that the terms “first”, “second”, and the like in the description, claims and drawings of the present disclosure are used to distinguish similar objects, and need not be used to describe a specific order or sequence. It should be understood that data used in this way is interchangeable under appropriate circumstances such that the embodiments of the present disclosure described herein can be implemented in an order other than those illustrated or described herein. Implementations described in the following exemplary embodiments do not represent all embodiments consistent with the present disclosure, but are merely examples of devices and methods consistent with some aspects of the present disclosure as detailed in the appended claims. User information involved in the present disclosure may be information authorized by a user or fully authorized by all parties.

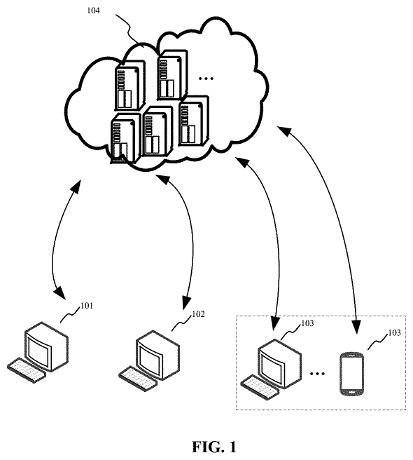

FIG. 1 is a schematic diagram of an implementation environment of a method for processing network data in accordance with an embodiment of the present disclosure. Referring to FIG. 1, the implementation environment may include a first terminal 101, a second terminal 102, a plurality of third terminals 103, and a server 104.

The first terminal 101 is a terminal where a first user performs a live streaming based on a first user account, i.e., a terminal where the first user account is logged, and the second terminal 102 is a terminal where a second user performs a live streaming based on a second user account, i.e., a terminal where the second user account is logged. The first user and the second user are called anchors. The plurality of third terminals 103 are terminals where audience watch live streaming content, and include a terminal where live streaming content of the first terminal 101 is watched, and a terminal where live streaming content of the second terminal 102 is watched.

The server 104 is configured to provide live streaming content services for the first terminal 101, the second terminal 102 and the plurality of third terminals 103, for example, it provides at least one of the live streaming content of the firs terminal 101 and the live streaming content of the second terminal 102 for the first terminal 101, the second terminal 102 and the plurality of third terminals 103. The server 104 is a single server, or the server 104 is a server cluster formed of a plurality of servers, or the server 104 is a cloud computing platform, a virtualization center, or the like.

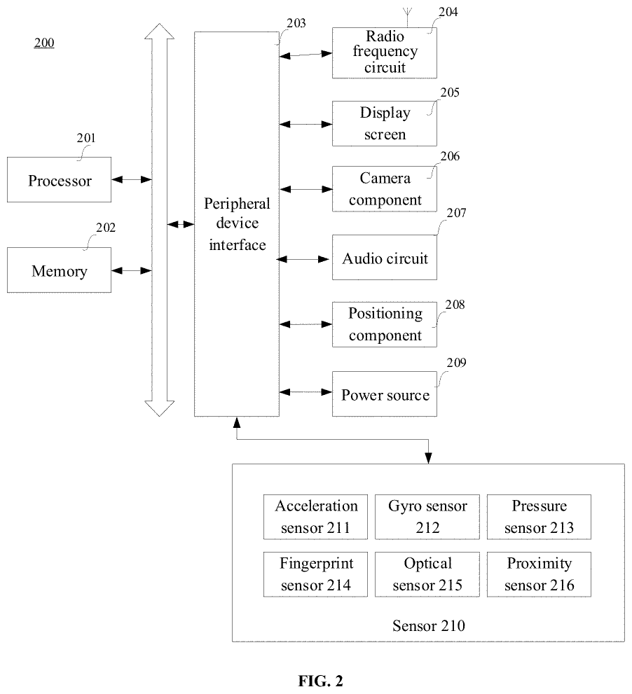

For example, FIG. 2 is a structural block diagram of a terminal 200 in accordance with one embodiment of the present disclosure. The terminal 200 may be a smart phone, a tablet computer, an Moving Picture Experts Group Audio Layer III (MP3) player, an Moving Picture Experts Group Audio Layer IV (MP4) player, a laptop or desk computer. The terminal 200 may also be called a user equipment (UE), a portable terminal, a laptop terminal, a desk terminal, or the like.

Generally, the terminal 200 includes a processor 201 and a memory 202.

The processor 201 may include one or more processing cores, such as a 4-core processor and an 8-core processor. The processor 201 may be formed by at least one hardware of a digital signal processor (DSP), a field-programmable gate array (FPGA), and a programmable logic array (PLA). The processor 201 may also include a main processor and a coprocessor. The main processor is a processor for processing the data in an awake state, and is also called a central processing unit (CPU). The coprocessor is a low-power-consumption processor for processing the data in a standby state. In some embodiments, the processor 201 may be integrated with a graphics processing unit (GPU), which is configured to render and draw the content that needs to be displayed by a display screen. In some embodiments, the processor 201 may also include an Artificial Intelligence (AI) processor configured to process computational operations related to machine learning.

The memory 202 may include one or more computer-readable storage mediums, which can be non-transitory. The memory 202 may also include a high-speed random-access memory, as well as a non-volatile memory, such as one or more disk storage devices and flash storage devices. In some embodiments, the non-transitory computer-readable storage medium in the memory 202 is configured to store at least one instruction. The at least one instruction is configured to be executed by the processor 201 to implement the following steps: displaying a live streaming interface of a first user account logged on to a first terminal, the live streaming interface including an entrance for initiating answering; in response to receiving a trigger instruction for the entrance, acquiring merged live streaming content and a question item, wherein the merged live streaming content is generated based on live streaming content of the first user account and live streaming content of a second user account; displaying the merged live streaming content and the question item; and displaying an answering result of the question item on the live streaming interface.

In some embodiments, the terminal 200 also optionally includes a peripheral device interface 203 and at least one peripheral device. The processor 201, the memory 202, and the peripheral device interface 203 may be connected by a bus or a signal line. Each peripheral device may be connected to the peripheral device interface 203 by a bus, a signal line or a circuit board. For example, the peripheral device includes at least one of a radio frequency circuit 204, a touch display screen 205, a camera 206, an audio circuit 207, a positioning component 208 and a power source 209.

The peripheral device interface 203 may be configured to connect at least one peripheral device associated with an input/output (I/O) to the processor 201 and the memory 202. In some embodiments, the processor 201, the memory 202 and the peripheral device interface 203 are integrated on the same chip or circuit board. In some other embodiments, any one or two of the processor 201, the memory 202 and the peripheral device interface 203 may be implemented on a separate chip or circuit board, which is not limited in the present embodiment.

The radio frequency circuit 204 is configured to receive and transmit an radio frequency (RF) signal, which is also referred to as an electromagnetic signal. The radio frequency circuit 204 communicates with a communication network and other communication devices via the electromagnetic signal. The radio frequency circuit 204 converts the electrical signal into the electromagnetic signal for transmission, or converts the received electromagnetic signal into the electrical signal. Optionally, the radio frequency circuit 204 includes an antenna system, an RF transceiver, one or more amplifiers, a tuner, an oscillator, a digital signal processor, a codec chipset, a subscriber identity module card, and the like. The radio frequency circuit 204 can communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 204 may also include near-field communication (NFC) related circuits, which is not limited in the present disclosure.

The display screen 205 is configured to display a user interface (UI). The UI may include graphics, text, icons, videos, and any combination thereof. When the display screen 205 is a touch display screen, the display screen 205 also has the capacity to acquire touch signals on or over the surface of the display screen 205. The touch signal may be input into the processor 201 as a control signal for processing. At this time, the display screen 205 may also be configured to provide virtual buttons and/or virtual keyboards, which are also referred to as soft buttons and/or soft keyboards. In some embodiments, one display screen 205 may be disposed on the front panel of the terminal 200. In some other embodiments, at least two display screens 505 may be disposed respectively on different surfaces of the terminal 200 or in a folded design. In further embodiments, the display screen 205 may be a flexible display screen disposed on the curved or folded surface of the terminal 200. Even the display screen 205 may have an irregular shape other than a rectangle; that is, the display screen 205 may be an irregular-shaped screen. The display screen 205 may be a liquid crystal display (LCD) screen, an organic light-emitting diode (OLED) screen, or the like.

The camera component 506 is configured to capture images or videos. In some embodiments of the present disclosure, the camera component 506 includes a front camera and a rear camera. Usually, the front camera is placed on the front panel of the virtual reality display device, and the rear camera is placed on the back of the virtual reality display device. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera component 506 may also include a flashlight. The flashlight may be a mono-color temperature flashlight or a two-color temperature flashlight. The two-color temperature flash is a combination of a warm flashlight and a cold flashlight and can be used for light compensation at different color temperatures.

The audio circuit 207 may include a microphone and a speaker. The microphone is configured to collect sound waves of users and environments, and convert the sound waves into electrical signals which are input into the processor 201 for processing, or input into the RF circuit 204 for voice communication. For the purpose of stereo acquisition or noise reduction, there may be a plurality of microphones respectively disposed at different locations of the terminal 200. The microphone may also be an array microphone or an omnidirectional acquisition microphone. The speaker is then configured to convert the electrical signals from the processor 201 or the radio frequency circuit 204 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 207 may also include a headphone jack.

The positioning component 208 is configured to locate the current geographic location of the terminal 200 to implement navigation or a location based service (LBS). The positioning component 808 may be the global positioning system (GPS) from the United States, the Beidou positioning system from China, the Grenas satellite positioning system from Russia or the Galileo satellite navigation system from the European Union

The power source 209 is configured to power up various components in the terminal 200. The power source 209 may be alternating current, direct current, a disposable battery, or a rechargeable battery. When the power source 209 includes the rechargeable battery, the rechargeable battery may a wired rechargeable battery or a wireless rechargeable battery. The wired rechargeable battery is a battery charged by a cable line, and wireless rechargeable battery is charged by a wireless coil. The rechargeable battery may also support the fast charging technology.

In some embodiments, terminal 200 also includes one or more sensors 210. The one or more sensors 210 include, but not limited to, an acceleration sensor 211, a gyro sensor 212, a pressure sensor 213, a fingerprint sensor 214, an optical sensor 215 and a proximity sensor 216.

The acceleration sensor 211 is capable of detecting magnitudes of accelerations on three coordinate axes of a coordinate system established by the terminal 200. For example, the acceleration sensor 211 is configured to detect components of a gravitational acceleration on the three coordinate axes. The processor 201 may control the touch display screen 205 to display a user interface in a landscape view or a portrait view according to a gravity acceleration signal collected by the acceleration sensor 211. The acceleration sensor 211 may also be configured to collect motion data of a game or a user.

The gyro sensor 212 is capable of detecting a body direction and a rotation angle of the terminal 200, and can cooperate with the acceleration sensor 211 to collect a 3D motion of the user on the terminal 200. Based on the data collected by the gyro sensor 212, the processor 201 is capable of implanting the following functions: motion sensing (such as changing the UI according to a user's tilt operation), image stabilization during shooting, game control and inertial navigation.

The pressure sensor 213 may be disposed on a side frame of the terminal 200 and/or a lower layer of the touch display screen 205. When the pressure sensor 213 is disposed on the side frame of the terminal 200, a user's holding signal to the terminal 200 can be detected. The processor 201 is capable of performing left-right hand recognition or quick operation according to the holding signal collected by the pressure sensor 213. When the pressure sensor 213 is disposed on the lower layer of the touch display screen 205, the processor 201 controls an operable control on the UI according to a user's pressure operation on the touch display screen 205. The operable control includes at least one of a button control, a scroll bar control, an icon control and a menu control.

The fingerprint sensor 214 is configured to collect a user's fingerprint. The processor 201 identifies the user's identity based on the fingerprint collected by the fingerprint sensor 214, or the fingerprint sensor 214 identifies the user's identity based on the collected fingerprint. When the user's identity is identified as trusted, the processor 201 authorizes the user to perform related sensitive operations, such as unlocking the screen, viewing encrypted information, downloading software, paying, and changing settings. The fingerprint sensor 214 may be provided on the front, back, or side of the terminal 200. When the terminal 200 is provided with a physical button or a manufacturer's Logo, the fingerprint sensor 214 may be integrated with the physical button or the manufacturer's Logo.

The optical sensor 215 is configured to collect ambient light intensity. In one embodiment, the processor 201 may control the display brightness of the touch display screen 205 according to the ambient light intensity collected by the optical sensor 215. For example, when the ambient light intensity is high, the display brightness of the touch display screen 205 is increased; and when the ambient light intensity is low, the display brightness of the touch display screen 205 is decreased. In another embodiment, the processor 201 may also dynamically adjust shooting parameters of the camera component 206 according to the ambient light intensity collected by the optical sensor 215.

The proximity sensor 216, also referred to as a distance sensor, is usually disposed on the front panel of the terminal 200. The proximity sensor 216 is configured to capture a distance between the user and a front surface of the terminal 200. In one embodiment, when the proximity sensor 216 detects that the distance between the user and the front surface of the terminal 200 becomes gradually smaller, the processor 201 controls the touch display screen 205 to switch from a screen-on state to a screen-off state. When it is detected that the distance between the user and the front surface of the terminal 200 gradually increases, the processor 201 controls the touch display screen 205 to switch from the screen-off state to the screen-on state.

It will be understood by those skilled in the art that the structure shown in FIG. 2 does not constitute a limitation to the terminal 200, and may include more or less components than those illustrated, or combine some components or adopt different component arrangements.

In an exemplary embodiment, a storage medium storing at least one instruction therein is provided an instruction, e.g., a memory 202 storing at least one instruction. The at least one instruction, when executed by the processor 201 of the terminal 200, enables the terminal 200 to perform the following steps:

displaying a live streaming interface of a first user account logged on to the first terminal, the live streaming interface including an entrance for initiating answering;

in response to receiving a trigger instruction for the entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

In some embodiments, the storage medium may be a non-temporary computer-readable storage medium, e.g., a read-only memory (ROM), a random access memory (RAM), a compact disc read-only memory (CD-ROM), a magnetic tape, a floppy disk, or an optical data storage device.

An exemplary embodiment provides a computer program product storing at least one instruction therein. The at least one instruction, when executed by the processor 201 of the terminal 200, enables the terminal 200 to perform the following steps:

displaying a live streaming interface of a first user account logged on to the first terminal, the live streaming interface including an entrance for initiating answering;

in response to receiving a trigger instruction for the entrance, acquiring merged live streaming content and a question item, the merged live streaming content being generated based on live streaming content of the first user account and live streaming content of a second user account;

displaying the merged live streaming content and the question item on the live streaming interface; and

displaying an answering result of the question item on the live streaming interface.

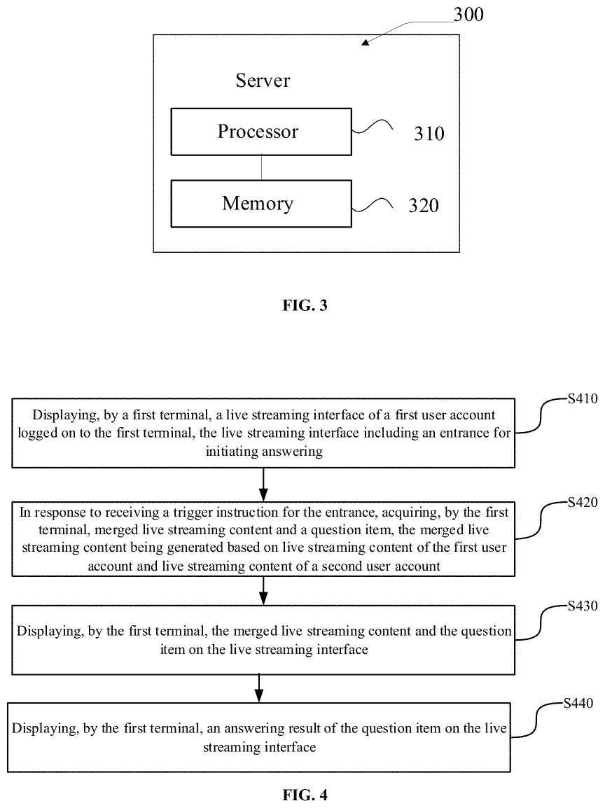

FIG. 3 is a block diagram of a server in accordance with an exemplary embodiment. The server 300 may be much different due to different configurations or performance, and may include at least one processor 310 and at least one memory 320 with at least one instruction stored therein. The at least one instruction, when loaded and executed by the at least one processor 310 of the server 300, enables the server 300 to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

The server may also be provided with components such as a wired or wireless network interface, a keyboard and an input/output (I/O) interface for facilitating input and output. The server may further include other components for implementing device functions, which will not be repeated herein.

In an exemplary embodiment, a storage medium storing at least one instruction therein is further provided, e.g., a memory 320 including at least one instruction. The at least one instruction, when executed by the processor 301 of the server 300, enables the server 300 to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

In some embodiments, the storage medium may be a non-temporary computer-readable storage medium, e.g., a ROM, a RAM, a CD-ROM, a magnetic tape, a floppy disk and an optical data storage device.

In an exemplary embodiment, a computer program product storing at least one instruction therein is further provided. The at least one instruction, when executed by the processor 310 of the server 300, enables the server 300 to perform the following steps:

in response to receiving answering requests from a first terminal and a second terminal, generating merged live streaming content based on live streaming content of a first user account logged on to the first terminal and live streaming content of a second user account logged on to the second terminal;

sending the merged live streaming content and a question item to the first terminal, the second terminal and a plurality of third terminals; and

in response to receiving an answer to the question item from any one of the first terminal, the second terminal and the plurality of third terminals, sending an answering result of the question item to the first terminal, the second terminal and the plurality of third terminals.

FIG. 4 is a flow chart of a method for processing network data in accordance with an exemplary embodiment. As shown in FIG. 4, the method is applicable to a first terminal, and includes the following steps.

In step 410, the first terminal displays a live streaming interface of a first user account logged on to the first terminal. The live streaming interface includes an entrance for initiating answering.

In step S420, in response to receiving a trigger instruction for the entrance, the first terminal acquires merged live streaming content and a question item. The merged live streaming content is generated based on live streaming content of the first user account and live streaming content of a second user account.

In step S430, the first terminal displays the merged live streaming content and the question item on the live streaming interface.

In step S440, the first terminal displays an answering result of the question item on the live streaming interface.

In the present embodiment, the entrance for initiating answering is provided on the live streaming interface, such that an anchor quickly initiates a joint live streaming with another anchor. Answering is performed during the joint live streaming. The answering result of the question item is displayed on the live streaming interface. Therefore, this answering process provides a new interaction mode to enable the two anchors to perform live streaming simultaneously and interact with each other, and also to enable audience in live streaming rooms of the two anchors to participate in the answering process, enhancing the interactivity in the live streaming rooms.

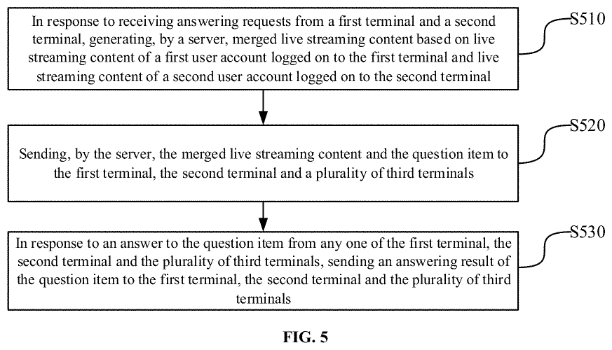

FIG. 5 is a flow chart of a method for processing network data in accordance with an exemplary embodiment. As shown in FIG. 5, the method is applicable to a server, and includes the following steps.

In step S510, in response to receiving answering requests from a first terminal and a second terminal, the server generates merged live streaming content based on live streaming content of a first user account logged on to the first terminal and live streaming content of a second user account logged on to the second terminal.

In step S520, the server sends the merged live streaming content and a question item to the first terminal, the second terminal and a plurality of third terminals.

In step S530, in response to receiving an answer to the question item from any one of the first terminal, the second terminal and the plurality of third terminals, the server sends an answering result of the question item to the first terminal, the second terminal and the plurality of third terminals.

In the present embodiment, another anchor is assigned to an anchor initiating the answering request for a joint live streaming, and the question item is also assigned, such that the two anchors perform answering during the joint live streaming, audience in the live streaming rooms of the two anchors may participate in the answering process. The answering result of the question item is given after the participant users send the answer to the question item. Therefore, this answering process provides a new interaction mode to enable the two anchors to perform live streaming simultaneously and interact with each other, and also to enable the audience to participate in the answering process, enhancing the interactivity in the live streaming rooms.

FIG. 6 is a flow chart of a method for processing network data in accordance with an exemplary embodiment. As shown in FIG. 6, the method includes the following steps.

In step S601, a first terminal displays a live streaming interface of a first user account logged on to the first terminal. The live streaming interface includes an entrance for initiating answering.

The first user account is a user account currently logged on to a live streaming application on the first terminal and performs a live streaming in a live streaming room based on the live streaming application.

In an embodiment of the present disclosure, during the live streaming of the first user account, the first terminal collects live streaming content of the first user account and sends the collected live streaming content to a server, and the server sends the received live streaming content to an audience user account end of the live streaming room. After receiving the live streaming content of the first user account, any terminal displays the live streaming interface including the live streaming content of the first user account.

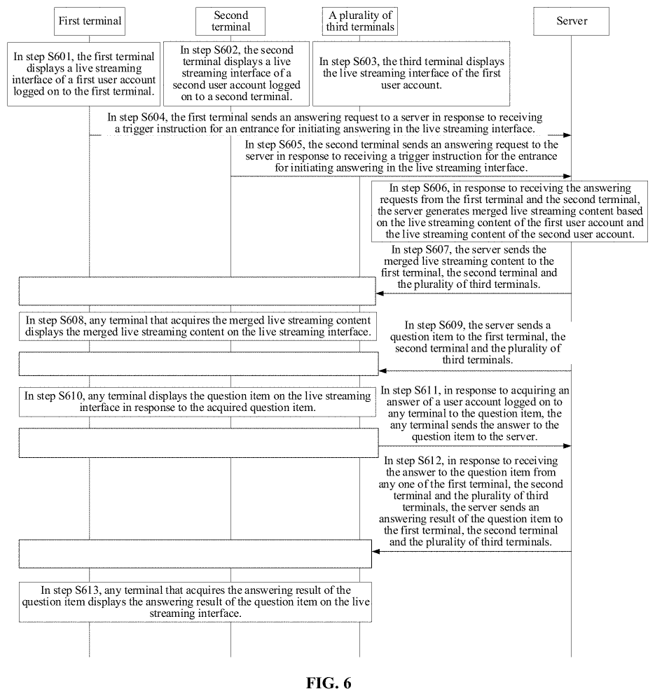

The first terminal provides an entrance for initiating answering on the live streaming interface, and the first user account initiates an answering process via the entrance. The entrance is directly displayed on the live streaming interface, or the first terminal is triggered to display the entrance on the live streaming interface when a certain button on the live streaming interface is tapped. FIG. 7 is a schematic diagram of a live streaming interface. As shown in FIG. 7, the first terminal displays the entrance in the lower area of the live streaming interface.

In step S602, a second terminal displays a live streaming interface of a second user account logged on to a second terminal. The live streaming interface includes an entrance for initiating answering.

Step S602 is similar to step S601, which is thus not described herein any further.

In an embodiment of the present disclosure, the live streaming interface of each user account includes an entrance for initiating answering, such that each anchor may initiate account matching and perform answering during a joint live streaming.

In step S603, a third terminal displays the live streaming interface of the first user account.

A third user account currently logs in a live streaming application on the third terminal and enters the live streaming room of the first user account based on the live streaming application.

In some embodiments, a third user taps an application icon of the live streaming application on the third terminal to trigger the third terminal to display an interface of the live streaming application. The interface of the live streaming application may provide live streaming room entrances of a plurality of live streaming rooms. The third user taps the live streaming room entrance of the first user account to trigger the third terminal to display the live streaming interface of the first user account. The third terminal displays the live streaming interface based on content currently performed in a first live streaming room, i.e., the live streaming content of the first user account. For example, the third terminal receives the live streaming content of the first user account from the server, and then displays the live streaming interface including the live streaming content of the first user account.

FIG. 8 is a schematic diagram of an interface of a live streaming application. As shown in FIG. 8, the live streaming room entrances in the interface of the live streaming application display corresponding marks based on the contents currently performed in the live streaming rooms, such as mark 1, mark 2, mark 3 and mark 4 in FIG. 8. For example, if music is playing in the streaming room, the mark may be a note icon, and if singing is performed in the streaming room, the mark may be a microphone icon.

An embodiment of the present disclosure takes that the third user account enters the live streaming room of the first user account and serves as an audience user account of the first user account as an example for explanation. In other disclosed embodiments, the third user account enters the live streaming room of the second user account and serves as an audience user account of the second user account. Accordingly, the third terminal displays the live streaming interface of the second user account, and its display process is similar to that in which the third terminal displays the live streaming interface of the first user account, and is thus not described herein any further.

It should be noted that an embodiment of the present disclosure only takes that the first terminal, the second terminal and the third terminals display the live streaming interfaces in the order of steps S601, S602, and S603 as an example for explanation, However, in other disclosed embodiments, the above display order may be in other orders, which will not be limited in the embodiments of the present disclosure.

In step S604, the first terminal sends an answering request to a server in response to receiving a trigger instruction for the entrance for initiating answering in the live streaming interface.

In an embodiment of the present disclosure, the user using the first user account taps the entrance for initiating answering on the live streaming interface when the first terminal displays the live streaming interface, such that the first terminal receives the trigger instruction for the entrance and sends the answering request to the server. The answering request carries the first user account.

In step S605, the second terminal sends an answering request to the server in response to receiving a trigger instruction for the entrance for initiating answering in the live streaming interface.

Step S605 is similar to step S604, which is thus not described herein any further.

An embodiment of the present disclosure only takes that the first terminal and the second terminal send the answering requests to the server in the order of steps S604 and S605 as an example for explanation. However, in other disclosed embodiments, the above-mentioned sending order may be in other orders, which will not be limited in the embodiments of the present disclosure.

In step S606, in response to receiving the answering requests of the first terminal and the second terminal, the server generates merged live streaming content based on the live streaming content of the first user account and the live streaming content of the second user account.

In an embodiment of the present disclosure, the server randomly assigns the anchors who will perform answering together, and before generating the merged live streaming content, the server may also execute any one of the following steps: from at least two user accounts initiating answering requests, randomly selecting two user accounts as the first user account and the second user account; or, in response to an answering request of the first terminal, selecting one of the at least two user accounts initiating the answering requests as the second user account;

or, in response to an answering request of the second terminal, selecting one of the at least two user accounts initiating the answering requests as the first user account. The server may adopt any one of the above account matching modes to obtain two user accounts to perform answering together, thereby improving the flexibility in account matching.

In step S607, the server sends the merged live streaming content to the first terminal, the second terminal and the plurality of third terminals.

The server sends the merged live streaming content to the terminals where the user accounts in the two live streaming rooms are logged.

In step S608, any terminal displays the merged live streaming content on the live streaming interface when acquiring the merged live streaming content.

Since any terminal displays the live streaming contents of two user accounts on the live streaming interface, video connection is established between the first user account and the second user account, i.e., a joint live streaming is realized between the first user account and the second user account.

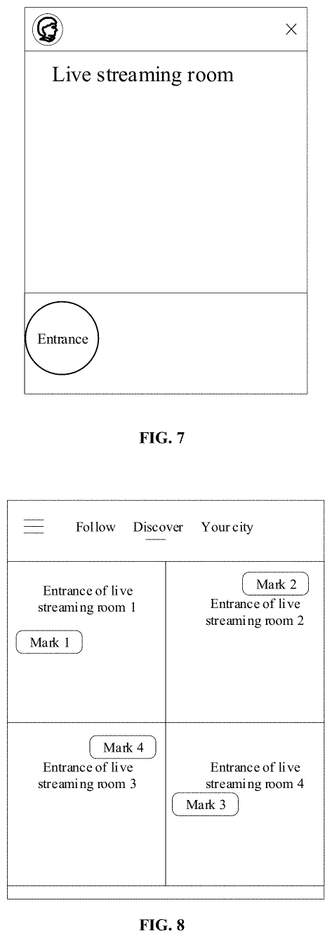

FIG. 9 is a schematic diagram of a live streaming interface. As shown in FIG. 9, the live streaming interface includes two display areas, one is intended to display the live streaming content of the first user account, e.g., a live streaming picture on the left side of FIG. 9, and the other is intended to display the live streaming content of the second user account, e.g., a live streaming picture on the right side of FIG. 9.

In some embodiments, after receiving the answering requests from the first terminal and the second terminal, the server sends a first answering party and a second answering party to the first terminal, the second terminal and the plurality of third terminals. The first answering party includes a user account teamed up with the first user account, and the second answering party includes a user account teamed up with the second user account. After receiving the first answering party and the second answering party, any terminal displays the first answering party and the second answering party on the live streaming interface. By letting the audience user accounts of the two live streaming rooms select to join the answering parties of the anchors to participate in answering, the interactivity in the live streaming rooms can be improved. The answering party displayed on the live streaming interface of any terminal is represented by profile pictures. As shown in FIG. 9, the profile pictures of the first answering party are displayed on the left side, e.g., two profile pictures on the left side of FIG. 9, and the profile pictures of the second answering party are displayed on the right side, e.g., one profile picture on the right side of FIG. 9.

In some embodiments, the server sends a teaming reminder message to the first terminal, the second terminal and the plurality of third terminals. The teaming reminder message is intended to prompt to join the first answering party or the second answering party. Each terminal that receives the teaming reminder message displays the teaming reminder message on the live streaming interface. By sending the teaming reminder messages to the two anchors and the audience, the audience may select to join the answering party of any anchor according to the teaming reminder message. By sending the answering parties to the two anchors and the audience, these users may learn about users in the same answering parties as themselves. As shown in FIG. 9, the terminal displays the teaming reminder message “waiting for teammates to join . . . ” on the live streaming interface, indicating that the anchors of both parties are waiting for audiences to join their own answering parties. Countdown, e.g., 10s, is displayed while the teaming reminder message is displayed.

Each terminal displays the third user account in the corresponding display area of the first answering party if the third user account selects to join the first answering party. Each terminal may display the third user account in the corresponding display area of the second answering party if the third user account selects to join the second answering party. In some embodiments, the live streaming interface displayed by the third terminal includes a first join button and a second join button. The first join button is configured for the audience to join the first answering party, and a join instruction for joining the first answering party is triggered if the user using the user account taps the first join button. The second join button is configured for the audience to join the second answering party, and the join instruction for joining the second answering party is triggered if the user using the user account taps the second join button. In other embodiments, the live streaming interface displayed on the third terminal displays one join button, and after the user using the user account taps this join button, the terminal is triggered to display two party options, which are for joining the first answering party and the second answering party respectively. If the user using the user account selects to tap the option for joining the first answering party, the join instruction for joining the first answering party is triggered; and if the user using the user account selects to tap the option for joining the second answering party, the join instruction for joining the second answering party is triggered.

The third terminal that receives the join instruction displays the third user account in the corresponding display area of the answering party indicated by the join instruction. In some embodiments, the third terminal receives the join instruction for joining the first answering party and sends a joining request to the server. The joining request is intended to request to join the first answering party. After receiving the joining request from the third terminal, the server sends a user account joining message of the third user account to the first terminal, the second terminal, and the plurality of third terminals, and the user account joining message is intended to instruct the third user account to join the first answering party. The user account joining message carries the third user account. In response to receiving the user account joining message of the third user account, any terminal displays the third user account in the corresponding display area of the first answering party. This joining process is described by taking that the third terminal receives the join instruction for joining the first answering party, and each terminal displays the third user account in the corresponding display area of the first answering party as an example. In other disclosed embodiments, if the third terminal receives a join instruction for joining the second answering party, each terminal displays the third user account in the corresponding display area of the second answering party.

By supporting real-time video connection between one anchor and another anchor, and also supporting the audience to select parties to join, this teaming mode promotes the interaction between the anchors and the audience and allows people who do not like to start a live streaming to feel more involved while stimulating more people to start live streaming. At the same time, this teaming mode also allows people who do not like to start streaming to feel more involved.

In step S609, the server sends a question item to the first terminal, the second terminal and the plurality of third terminals.

In some embodiments, in response to receiving an answering start request from the first terminal or the second terminal, the server sends the question item assigned in this round to the terminals where the user accounts in the first live streaming room and the second live streaming room are logged. In some embodiments, the answering start request is sent by the first terminal or the second terminal at the end of teaming, i.e., when a display duration of the teaming reminder message reaches a preset duration, e.g., at the end of countdown in FIG. 9.

In some embodiments, before sending the question item, the server also performs the following step: from a question item library, assigning the question item to the first user account and the second user account. There are multiple question items stored in the question item library, and the server selects at least one question item as the question item in this round of answering, randomly or according to a predetermined rule. For example, the multiple question items carry marks for indicating the selection order, and the higher the mark is in the selection order, the more probably it is selected. Since the server assigns the question item to two anchor accounts that perform answering together, the anchor accounts do not need to set a question by themselves, which improves the answering efficiency.

In some embodiments, in addition to sending the question item, the server may also send at least one of the followings to each terminal: a plurality of candidate answers to the question item, and a question audio for the question item.

If the server only sends the question item, the question item is displayed on the live streaming interface, and a user needs to enter an answer on the terminal. If the server sends the plurality of candidate answers while sending the question item, the question item and the plurality of candidate answers are displayed on the live streaming interface, and the user directly selects the answer, which improves the efficiency in answering. The question audio includes a song, accordingly, the question item includes guessing the name of the song, and the candidate answers include names of multiple songs.

In some embodiments, the question item includes one or more items. In the case that the question item includes one item, this item may correspond to a plurality of candidate answers and one question audio. In the case that the question item includes a plurality of items, each item may correspond to a plurality of candidate answers and one question audio.

An embodiment of the present disclosure takes that the server sends the merged live streaming content and the question item according to the order of steps S607 and S609 as an example. In other disclosed embodiments, the server sends the merged live streaming content and the question item at the same time.

In step S610, in response to the acquired question item, any terminal displays the question item on the live streaming interface.

In some embodiments, any terminal displays one question window on the live streaming interface, and the question item is displayed in the question window. In the case that the server sends the candidate answers, any terminal also acquires the plurality of candidate answers to the question item, and the plurality of candidate answers are displayed when the question item is displayed on the live streaming interface. In the case that the server sends the question audio, any terminal also acquires the question audio of the question item, and the question audio is played when the question item is displayed on the live streaming interface. By providing the candidate answers and the question audio while providing the question item, the answering form is enriched.

FIG. 10 is a schematic diagram of a live streaming interface. As shown in FIG. 10, the terminal displays one question window in the lower area of the live streaming interface, and the question item and the plurality of candidate answers, e.g., a name 1, a name 2 and a name 3, are displayed in the question window. The users select the answers that they think are correct from the plurality of candidate answers.

An embodiment of the present disclosure only takes that any terminal sequentially displays the merged live streaming content and the question item on the live streaming interface in the order of steps S608 to S610 as an example for explanation. However, in other disclosed embodiments, any terminal displays the merged live streaming content and the question item on the live streaming interface at the same time, which will not be limited in the embodiments of the present disclosure.

In step S611, in response to acquiring an answer of a user account logged on to any terminal to the question item, the any terminal sends the answer to the question item to the server.

In an embodiment of the present disclosure, in the process that any terminal displays the question item, if the user account logged on to the any terminal answers the question item, e.g., by selecting one candidate answer from the plurality of candidate answers and submitting the chosen candidate answer, or entering one answer in an answering box by means of text input or voice input and submitting the answer, in response to a submission instruction of the answer, the first terminal acquires the answer corresponding to the submission instruction as the answer of the user account logged on to the any terminal to the question item.

By supporting the anchors and the audience to participate in live answering in the live streaming rooms, such as a game of guessing the name of a song (a system plays a song, users participating in the game may select the name of the song), allowing the multiple anchors to play the answering game in the state of live streaming. Participation of the users in the interaction through games can not only produce an entertainment effect and increase the playing amount, but also prolong the watching time of audiences, providing the audience with more opportunities to demonstrate their song recognition capabilities.

In step S612, in response to receiving the answer to the question item from any one of the first terminal, the second terminal and the plurality of third terminals, the server sends an answering result of the question item to the first terminal, the second terminal and the plurality of third terminals.

In an embodiment of the present disclosure, the server stores the correct answer to the question item. When received, the answer received from any terminal is compared with the correct answer to the question item to obtain the answering result of the question item. The answering result is intended to indicate whether the answer received from any terminal is the correct answer, i.e., whether the answer of the any user account logged on to any terminal to the question item is correct. In the case that the server sends a plurality of candidate answers to the question item, the answering result is intended to indicate whether any user account logged on to any terminal selects the correct answer.

In step S613, any terminal that acquires the answering result of the question item displays the answering result of the question item on the live streaming interface.

Once the answering result of the user account is acquired, any terminal displays the answering result on the live streaming interface, such that all users in the live streaming room can see the answering result. After the user answers the question item, feeding back in real time whether the user's answer is correct may allow the user's operation to be fed back in time, and thus, improves the user's answering experience. In the case of forming the first answering party and the second answering party by division, each terminal displays, on the live streaming interface, the answering results of the user accounts that answer the question item in the first answering party and the second answering party.

Regarding display of the answering results, in some embodiments, displaying the answering results of the question item on the live streaming interface includes at least one of the followings: displaying the user accounts that select the correct answer in the corresponding display area of the correct answer in the plurality of candidate answers; and displaying the user accounts that select a wrong answer in the corresponding display area of the wrong answer in the plurality of candidate answers. If there are multiple wrong answers, the user accounts that select the wrong answers are displayed in the respective corresponding display area of the wrong answers. In some embodiments, the user accounts are represented by profile pictures. By displaying the user accounts that select the corresponding candidate answers in the respective corresponding display areas of the plurality of candidate answers, the anchors and the audience can visually see selection of the candidate answers.

In response to a correct answer of any user account to the question item, any terminal displays a first special effect on the live streaming interface. The first special effect is intended to indicate that any user account acquires a virtual resource corresponding to the question item. The virtual resource may be scores or in other forms.

In the case of forming the first answering party and the second answering party by division, in some embodiments, in response to a correct answer of any user account to the question item, any terminal displays a second special effect on the live streaming interface. The second special effect is intended to indicate that the any user account assists an answering party to which the any user account belongs with a virtual resource corresponding to the question item.

In a scenario of party forming, if a member of a party gives a correct answer, the second special effect is displayed to indicate that the teammate assists the anchor, and the anchor in the party acquires the corresponding virtual resource, which promotes the interaction between the anchor and the audience and improves the answering experience.

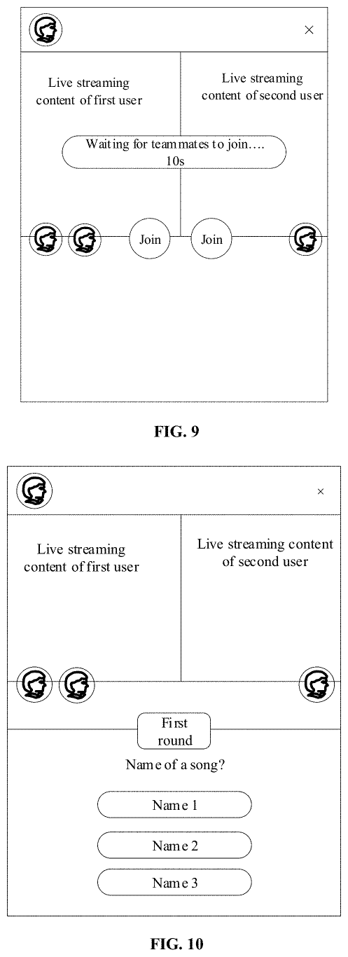

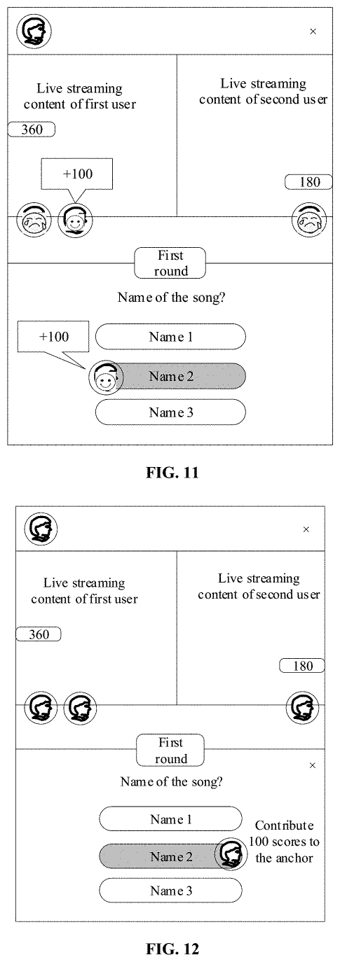

FIG. 11 is a schematic diagram of a live streaming interface. As shown in FIG. 11, the profile picture of the first user account and the virtual resource won by the first user account, e.g., “+100” are displayed in the corresponding display area of the correct answer in the live streaming interface if the answer selected by the first user account is the correct answer.

FIG. 12 is a schematic diagram of a live streaming interface. As shown in FIG. 12, the profile picture of the third user is displayed in the corresponding display area of the correct answer in the live streaming interface and the virtual resource won by the third user to the anchor in the answering party to which the third user belongs if the answer selected by the third user is the correct answer. For example, “assist the anchor with 100 scores” is displayed in the position corresponding to the profile picture of the third user.

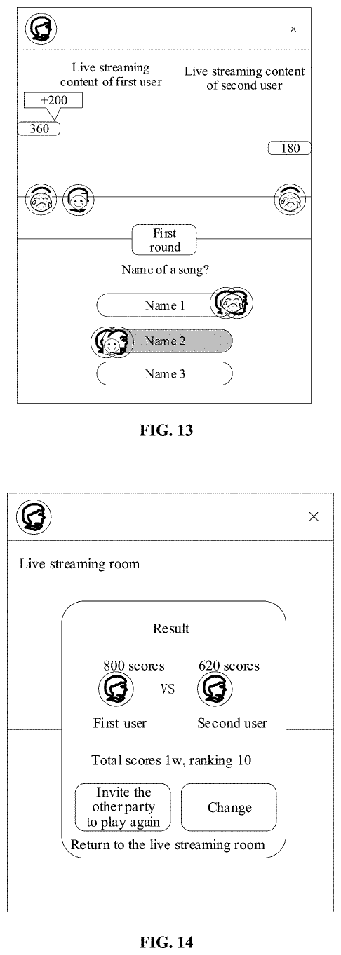

If there are multiple question items in this round of answering, and each question item has a preset answering duration, for each question item, participation of all participant user accounts will be announced at the end of answering this question item, and the user accounts that select the candidate answers will be displayed on the candidate answers to the question item, such that the users can visually see which users answer correctly, which users answer incorrectly, and how many people answer correctly or incorrectly, thereby improving the users' answering experience. FIG. 13 is a schematic diagram of a live streaming interface. As shown in FIG. 13, if two user accounts select the first candidate answer, profile pictures of the two user accounts may be displayed in the corresponding display area of the first candidate answer; and if other two user accounts select the second candidate answer, profile pictures of the other two user accounts may be displayed in the corresponding display area of the second candidate answer. Due to the limited size of the display area of the candidate answers, if multiple user accounts select the same candidate answer, profile pictures of the multiple user accounts, displayed on the candidate answer, partially overlap.

In some embodiments, in addition to displaying the user accounts in the corresponding display areas of the answers, the terminal also displays answering result identifiers on the user accounts to indicate whether the answer is correct. As shown in FIG. 13, the answer result identifier may be a sticker, e.g., a smiling face will be displayed if the answer is correct and a crying face will be displayed if the answer is wrong. The answer result identifier may also be in other forms, e.g., “v” is displayed if the answer is correct and “x” is displayed if the answer is wrong. The embodiments of the present disclosure will not limit the display form of the answering results as long as different answering results are distinguishable.

In the case of forming the first answering party and the second answering party by division, in some embodiments, any terminal displays the virtual resource of the first answering party and the virtual resource of the second answering party on the live streaming interface. By displaying the virtual resources of the two answering parties on the live streaming interface, the users in the live streaming rooms may visually see the virtual resources of their answering parties.

As shown in FIGS. 11, 12, and 13, the terminal displays the virtual resource of the first answering party in a live streaming content display area of the first user account in the live streaming interface, and displays the virtual resource of the second answering party in a live streaming content display area of the second user account. The two virtual resources are updated in time according to real-time answering of the user accounts in the two answering parties before this round of answering is over. The two virtual resources are used as cumulative virtual resources of two anchors at the end of this round of answering. As shown in FIG. 13, in addition to displaying the accumulative virtual resources of the first user account and the second user account (e.g., 360 scores and 180 scores in FIG. 13), virtual resources won by correct answering of the first user account or the second user account are also displayed, e.g., “+200” is displayed on the accumulative virtual resource 360 of the first user account if the first user account wins 200 scores by its correct answering.

In some embodiments, during answering, the third terminal also provides the third user account with a function of closing the question window. The third terminal that receives a close instruction for the question window closes the question window. As shown in FIG. 11, a close button, such as an “x” button, may be displayed at the upper right corner of the question window. The audience who do not want to participate in answering tap the close button so as to trigger the terminal to close the question window. By supporting the audience to close their own answering pop-up window, the audience′ answering experience may be improved.

It should be noted that steps S611 to S613 are processes in which any terminal sends the answers of the user accounts to the server, the server returns the answering result to any terminal, and the any terminal displays the answering result. In some embodiments, any terminal locally stores the correct answer to the question item, such that when acquiring the answers of the user accounts, any terminal directly compares the answers with the correct answer to the question item to determine and display the answering results. After self-determining the answering results, any terminal sends the answering results to the server, and the server sends them to each terminal for display.

In some embodiments, when this round of initiated answering ends, i.e., when this round of answering is over, the server acquires end-counting data of the first user account and the second user account according to answering of each user account in this round of answering, and sends the end-counting data of the first user account and the second user account to the first terminal, the second terminal, and the plurality of third terminals. The end-counting data include resources in this round, total resources, and user account ranking information.

The resources in this round are the sum of the virtual resources won by answering in this round. For example, the resources in this round of the first user account are the sum of the virtual resources won by answering in this round of the first user account, including the sum of the virtual resources won by answering of the first user account and the virtual resources assisted by other user accounts with the first user account. The total resources are the sum of the virtual resources won by answering in multiple rounds. For example, the total resource of the first user account is the sum of the resources in this round of the first user account and the virtual resources in the previous rounds.

The user account ranking information is intended to indicate indicating ranking of the multiple user accounts. The ranking information is determined according to the total resources of the multiple user accounts. The more the total resources are, the higher the ranking is. For example, the user account ranking information of the first user account is intended to indicate ranking information of the first user account in a first user account set, and the user account ranking information of the second user account is intended to indicate ranking information of the second user account in a second user account ranking information set. In some embodiments, the first user account set and the second user account set both include all user accounts answering the question within a preset time period, or the first user account set includes user accounts on a relation chain corresponding to the first user account and the second user account set includes user accounts on a relation chain corresponding to the second user account.

In some embodiments, in addition to the end-counting data of the first user account and the second user account, the server also acquires end-counting data of the third user account. For example, in the answering process, if the answer is correct, the third user account may win virtual resources for itself while assisting the anchor with virtual resources. The server acquires the end-counting data of the third user account according to the virtual resources won by the third user account in the answering process. The audience accumulate their own virtual resources while helping the anchors win the game, and participate in ranking based on the accumulated virtual resources, thereby having competitive consciousness.

In some embodiments, any terminal that acquires the end-counting data of the first user account and the second user account displays the end-counting data of the first user account and the second user account on the live streaming interface. For example, any terminal displays, on the live streaming interface, at least one of the ranking information of the first user account in the first user account set, or the ranking information of the second user account in the second user account set.

When acquiring the end-counting data of the first user account and the second user account, the first terminal displays resources in this round of the first user account, resources in this round of the second user account, the total resources of the first user account and the user account ranking information of the first user account. FIG. 14 is a schematic diagram of a live streaming interface. As shown in FIG. 14, the first terminal displays one result window on the live streaming interface, and end-counting data are displayed in the result window. For example, the first terminal displays that resources in this round of the first user account are 800 scores, resources in this round of the second user account are 620 scores, the total resources of the first user account are 1w (ten thousand) scores, and friends of the first user account rank 10. In some embodiments, the first terminal also displays the total resources of the second user account and the user account ranking information of the second user account. The second terminal is similar to the first terminal, which is thus not described herein any further.

If the third user account selects to join the answering party of either the first user account or the second user account, the third terminal displays resources in this round of the first user account, resources in this round of the second user account, and the total resources of any user account and the user account ranking information of the any user account. In some embodiments, the third terminal also displays the total resources and the user account ranking information of the other user account except for any one of the first user account and the second user account. In some embodiments, the third terminal also displays resources in this round, total resources, and the user account ranking information of the third user account.

Upon completion of answering, the server sends the end-counting data to the terminal where the anchor is and the terminal where the audience are, such that the anchor and the audience may visually see the end-counting status of this round of answering.

In some embodiments, in response to the end of this round of answering, the first terminal and the second terminal display an entrance for initiating the next round of answering. By providing the entrance for initiating the next round of answering after this round of answering is over, the two anchors of this round of answering may quickly initiate the next round of answering. Therefore, the experience is not interrupted, such that ordinary anchors and audience feel more involved for a long time.

In some embodiments, displaying the entrance for initiating the next round of answering includes at least one of the following steps: displaying an answering invitation entrance, which is configured to invite the second user account to the next round of answering; or, displaying a question initiation entrance, which is configured to initiate the next round of answering with a user account other than the second user account. After answering is over, in addition to displaying the record, the user's operation of playing again with the current competitor or playing with another competitor is also supported, which improves the flexibility in initiating the next round of answering. As shown in FIG. 14, the terminal displays an answering invitation entrance and an answering initiation entrance in the result window, e.g., a reminder message “invite the other party to play again” is displayed on the answering invitation entrance, and a reminder message “change” is displayed on the answering initiation entrance.

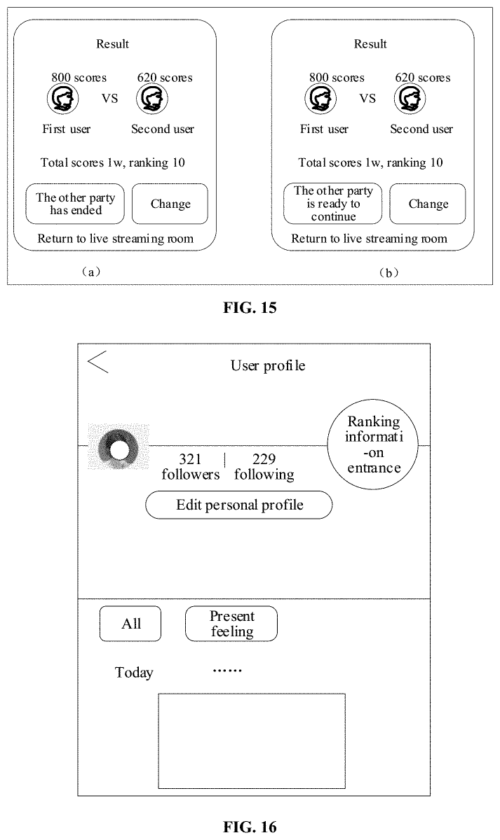

When the first terminal displays the result window including the end-counting data, if the second user account has ended live answering, e.g., the second user account has ended video connection, the first terminal displays a first answering status message of the second user account in the result window. The first answering status information is intended to indicate that the second user account has ended live answering. FIG. 15 is a schematic diagram of a result window. As shown in FIG. 15 (a), when the answering status message “the other party has ended” is displayed on the answering invitation entrance, it indicates that the anchor of the other party has ended. After answering is over, the user using the first user account that wants to continue the next round of answering with the currently assigned second user account taps the answering invitation entrance on the first terminal to trigger the answering process. Certainly, the user using the second user account that also wants to continue the next round of answering with the first user account also taps the answering invitation entrance to trigger the answering process. In this case, the terminal displays a second answering status message of the second user account in the result window. The second answering status information is intended to indicate that the user account of the other party is ready to continue the next round of answering. As shown in FIG. 15 (b), when the answering status message “the other party is ready to continue” is displayed on the answering invitation entrance, it indicates that the anchor of the other party invites the current anchor to continue playing. By supporting re-initiation of the next round of rounding at the end of this round of answering, it is convenient for the anchor to simply and quickly enter a next round of answering, such that the experience of the anchor is not interrupted.

In some embodiments, in response to receiving an information viewing instruction for the first user account, the terminal displays an information interface of the first user account. The information interface includes the first user account and the ranking information entrance. Information viewing instructions of the second user account and the third user account are the same as the information viewing instruction of the first user account, and thus, neither of them will be repeated. FIG. 16 is a schematic diagram of an information interface of a user account. As shown in FIG. 16, personal profiles of users may be displayed on the information interface of the user account. The ranking information entrance is as shown in the circle position in FIG. 16.

The terminal displays a ranking interface in response to receiving a triggering instruction for the ranking information entrance. The ranking interface includes a plurality of user accounts whose total resources rank the top preset number and their corresponding total resources. The ranking interface includes at least one of a ranking list within a preset time period or a correlated user account ranking list. The ranking list within the preset time period is intended to indicate a plurality of user accounts whose total resources rank the top preset number in all the user accounts answering the question within the preset time period.

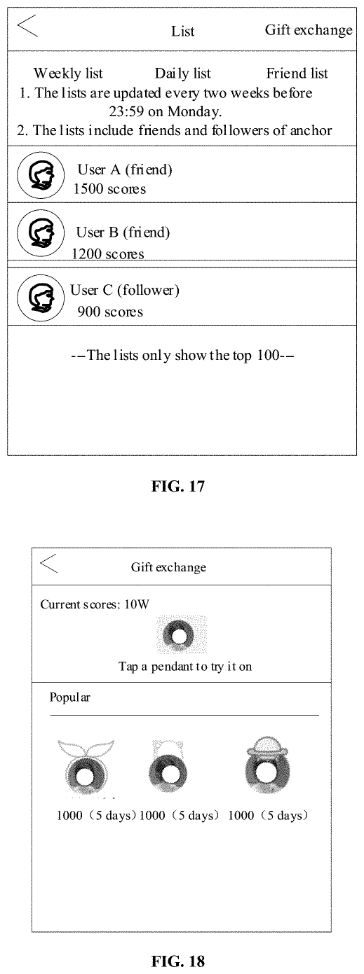

The correlated user account ranking list of the first user account is intended to indicate the first user account and a plurality of user accounts whose total resources rank the top preset number in the user accounts on the relation chain of the first user account. The correlated user account ranking lists of the second user account and the third user account are the same as the correlated user account ranking list of the first user account, and thus, neither of them will be repeated. By providing the ranking information entrance in the information interface of the user account, the users may view ranking of the users, and improving user friend ranking helps to form users' sense of competition. Therefore, the users will participate more in answering to improve their rankings. FIG. 17 is a schematic diagram of a ranking interface. As shown in FIG. 17, the ranking interface may include a weekly list, a daily list and a friend list. The ranking list may include a user A, a user B, a user C, and their respective virtual resources. The user A and the user B are friends of the current user, and the user C is a follower of the current user. The current user refers to a user to whom the ranking interface belongs.

In some embodiments, the ranking interface includes a virtual items exchange entrance. After displaying the ranking interface, in response to receiving a trigger instruction for the virtual items exchange entrance in the ranking interface, the terminal displays the virtual items exchange interface, including a plurality of virtual items and virtual resources required for exchange of each virtual item; in response to receiving an exchange instruction for a target virtual item in the plurality of virtual items, the terminal sends a virtual items exchange request to the server, and the virtual items exchange request is used for requesting to use a target number of virtual resources to exchange the target virtual item; and the terminal receives an exchange success message for indicating that the virtual item has been successfully exchanged. FIG. 18 is a schematic diagram of a virtual items exchange interface. As shown in FIG. 18, various virtual items are provided on the virtual items exchange interface. For example, the virtual items are head-mounted pendants, and a user may tap any one of them to try it on.

If the first user account successfully redeems the virtual item, the terminal displays the virtual item in the information interface of the first user account and displays the virtual item in a live streaming room entrance display area of the first user account in a target interface. The target interface is configured to provide live streaming room entrances of multiple user accounts. The multiple user accounts include the first user account. The second user account is similar to the first user account, which is thus not described herein any further. If the third user account successfully redeems the virtual item, the terminal displays the virtual item in the information interface of the third user account. If the third user account also registers for its own live streaming room, the terminal displays the virtual item in the live streaming room entrance display area of the third user account in the target interface.

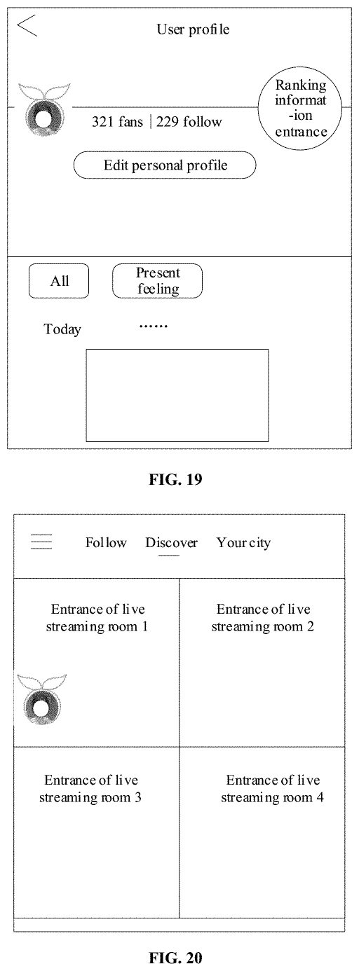

Taking that the terminal displays a virtual item in the information interface of the user account as an example, after the user account successfully redeems the virtual item, the terminal displays the virtual item in a preset position in the information interface of the user account. The preset position may be set according to the type of the virtual item. FIG. 19 is a schematic diagram of an information interface of a user account. As shown in FIG. 19, the virtual item is a head-mounted pendant, and the terminal displays the pendant on the profile picture of the user account in the information interface of the user account. FIG. 20 is a schematic diagram of a target interface. As shown in FIG. 20, the target interface includes live streaming room entrances of multiple user accounts, e.g., an entrance of live streaming room 1, an entrance of live streaming room 2, an entrance of live streaming room 3 and an entrance of live streaming room 4. The terminal may display the virtual item that has been redeemed by the user account on the live streaming room entrance of any user account, e.g., the terminal displays the head-mounted pendant on the live streaming room 1 entrance. By participating in answering, the users not only accumulate virtual resources, but also redeem virtual items (e.g., pendants) with the virtual resources on a platform, and use the pendants to show their uniqueness to achieve a certain sense of superiority.

The information interface of the user account is also called a personal homepage or a profile page, the ranking interface is called a list, and the virtual items are called virtual gifts. A list entrance is displayed on the profile page, and a user taps the list entrance to enter the list. A monthly list, a weekly list, a daily and a friend list highlight the user's game capabilities. The user enters a gift exchange interface from the list and redeems his favorite virtual gifts. The virtual gift is also time-efficient, i.e., the user may use the virtual gift within a period of time after redeeming it. The virtual gift redeemed by the user account is exhibited on the personal homepage and the target interface (a “your city” interface, a “discover” interface and a “follow” interface) provided with the live streaming room entrance of the user account in the form of a feed stream. The “your city” interface is configured to display live streaming room entrances of anchor accounts in the same city as the current user account. The “discover” interface is configured to display live streaming room entrances of anchor accounts popular in the system. The “follow” interface is configured to display live streaming room entrances of all anchor accounts followed by the current user account. The feed stream means an information stream that is constantly updated and presented to the user.

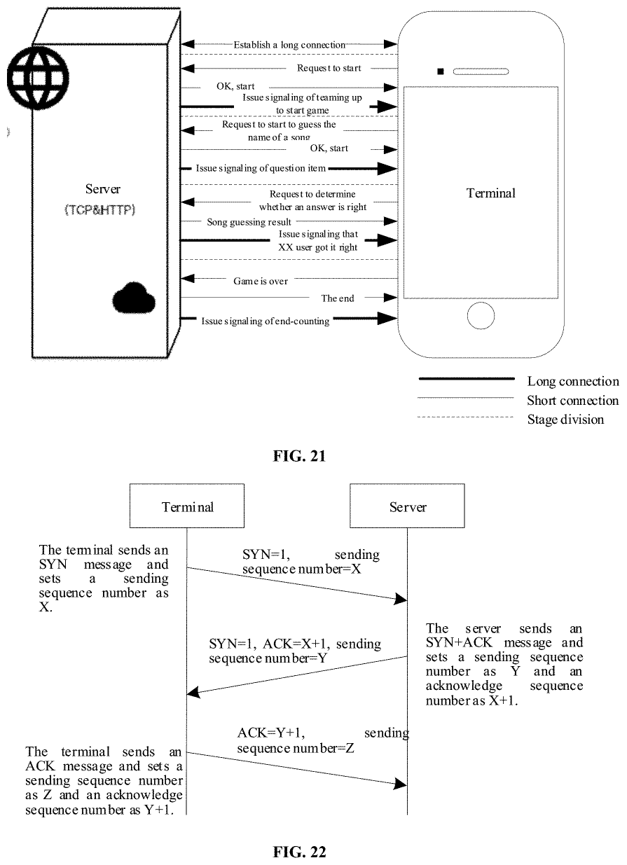

The above technical solution adopts a Transmission Control Protocol (TCP) downlink (the server issues signaling) and a terminal uplink, that is, a terminal actively initiates an HyperText Transfer Protocol (HTTP) request to run the entire process by the interaction between the server and the terminal (client). FIG. 21 is a schematic diagram showing a live streaming process of answering. As shown in FIG. 21, the whole live streaming process of answering includes multiple stages. Along connection is first established between the server and the terminal, and then the whole live streaming process of answering is realized in the way that a request is sent to the server by the terminal and the server issues signaling. The long connection may be established between the terminal and the server by a TCP three-way handshake process. FIG. 22 is a schematic diagram of TCP three-way handshake. As shown in FIG. 22, the first-way handshake is realized in the way that the terminal sends a synchronize sequence numbers (SYN) message, and sets a sending sequence number as X, the server sends an SYN+acknowledgement (ACK) message, and sets a sending sequence number as Y and an acknowledgement sequence number as X+1, and the terminal sends an ACK message, and sets a sending sequence number as Z, and an acknowledgement sequence number as Y+1.

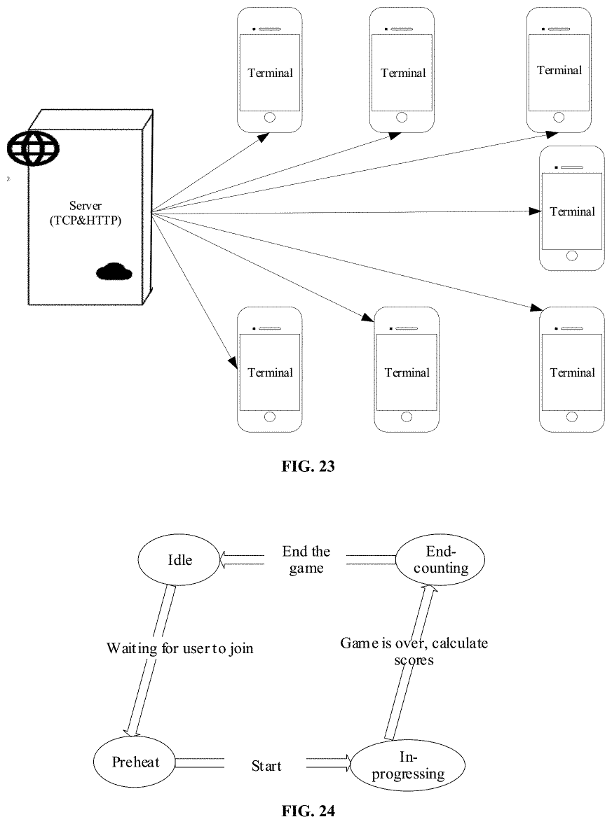

Taking that the live streaming question answering game is to guess the same of a song as an example, as shown in FIG. 21, after the long connection is established between the terminal and the server, the terminal requests to start the game. The server returns “OK, start” as a response message, and issues signaling “teaming up to start game”. The terminal requests to start guessing the name of the song, the server returns “OK, start” as the response message, and issues signaling of question item. The terminal requests to determine whether answer is correct, and the server returns a guessing result as a response, and issues signaling of “xx user got it right”. When the game is over, the server returns “the end” as a response message, the server issues signaling of end-counting data. FIG. 23 is a schematic diagram of one-to-many signaling interaction. As shown in FIG. 23, the server issues the one-to-way signaling. One signaling of the server is sent to multiple terminals. The server issues the signaling based on the long connection with the terminal. The terminal sends an HTTP request to the server based on the short connection, and the server sends a response message to the terminal based on the short connection. The long connection means that multiple data packets are continuously sent on one connection, and then the connection is interrupted. If no data packet is sent in a connection maintenance period, both parties need to send detection packets. The short connection means that one connection is established when two communication parties conduct data interaction, and the connection is interrupted upon completion of data transmission, i.e., sending of only one service is completed in each connection.

The terminal may send an HTTP request or an Hypertext Transfer Protocol Secure (HTTPS) request to the server based on the HTTP/HTTPS protocol. For example, when the user taps the answer, the terminal uses the HTTP request or HTTPS request to send the answer submitted by the user to the server to confirm whether the user's answer is correct or wrong. The server sends the answering result to a comment area of the live streaming room in the form of a feed stream, such that the comment area will display a comment “xx user got it right”.

The signaling issued by the server may be of the following types:

1.1.1 Control signaling

Control stages of the game (idle, preheat, in-progressing, end-counting)

1.1.2 Party join signaling

1.1.3 Question and answer setting signaling

1.1.4 User right feed signaling (for example, Zhang San got it right)

```
enum EventType {
  UNKNOWN=0;//Unknown
  CONTROL=1;//control signaling
  JOIN =2;//Team join signaling
  STARTQANDA=3;//question and
  answer setting signaling
  QAFEED=4;//user feed signaling
}
```

“EventType” object represents the event type (signaling type).

```
enum ClientStageType {
  UNKNOWN =0;/Unknown
  IDEL=1;//Idle
  PRE_HEAT=2;//Preheat
  IN_PROGRESSING=3;//In-progressing
  END_COUNTING=4;//End-counting
}
```

“ClientStageType” object represents the client stage type.

```
message ClientEventMessage {
  EventType eventType = 0;
  ClientStageType stageType = 1;
  String question=″″;
  String feedContent=″″;
  ...
}
```

“ClientEventMessage” object represents the client event message.

FIG. 24 is a schematic diagram of a state machine. The state machine is a mathematical model representing a limited number of states and such behaviors as transition and action between these states. As shown in FIG. 24, the state machine is mainly divided into the followings.

Idle state: the anchor does not register for live streaming question answering, taking the game of guessing the name of a song as an example, for the game is not enabled or the game is over; e.g., in steps S601 to S603, neither of the first user account and the second user account initiates the question answering request; alternatively, after step S613, this round of answering is over, and the anchor account gives up selecting the entrance for starting the next round of question answering, and then enters this state.

Preheat state: the audience of the anchor select to join the first answering party of the first user account or the second answering party of the second user; e.g., the audience user accounts in the two live streaming rooms in step S608 trigger the join instruction for joining the first answering party or the second answering party, and then enter this state.

In-progressing state: the anchor starts the game, receives a question and answers the question, and the audience also participate in answering the question together; e.g., the processes of steps S610 to S613 are in the in-progressing state, and the anchor account enters this state after initiating the question answering request.

End-counting state: When the game is over, end-counting of data is started, and the virtual resources are counted to obtain rankings of the total resources and the number of contributions from the audience; e.g., after step S613, this round of answering is over, the process in which the server performs end-counting and issues end-counting data is in the end-counting state, and the server enters the end-counting state after the question answering duration reaches a target duration.

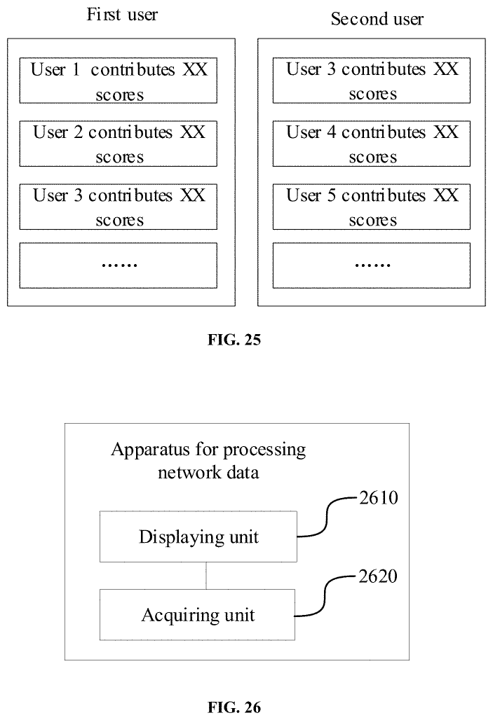

FIG. 25 is a schematic diagram of end-counting. As shown in FIG. 25, when the server performs end-counting, for the first user account, the server may rank the virtual resources assisted by all the user accounts in the answering party of the first user account, and use the sum of the virtual resources assisted by all the user accounts as the virtual resources of the first user account. For the second user account, the server may rank the virtual resources assisted by all the user account in the answering party of the second user account and use the sum of the virtual resources contributed by the user accounts as the virtual resources of the second user account.

In the present embodiment, the entrance for initiating answering is provided on the live streaming interface, such that the anchor quickly initiates a joint live stream with another anchor. Answering is performed during the joint live stream. An answering result of a question item is displayed on the live streaming interface. Therefore, this answering process provides a new interaction mode to enable the two anchors to perform live streams simultaneously and interact with each other, and also to enable audience in live streaming rooms of the two anchors to participate in the answering process, enhancing the interactivity in the live streaming rooms.

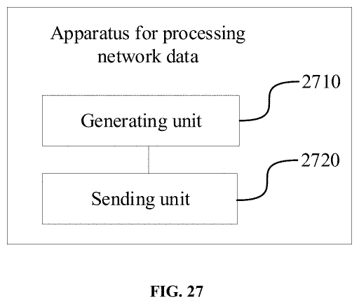

FIG. 26 is a block diagram of an apparatus for processing network data in accordance with an exemplary embodiment. Referring to FIG. 26, the apparatus includes a displaying unit 2610 and an acquiring unit 2620.

The displaying unit 2610 is configured to display a live streaming interface of a first user account logged on to the first terminal, wherein the live streaming interface includes an entrance for initiating answering.

The acquiring unit 2620 is configured to, in response to receiving a trigger instruction for the entrance in the live streaming interface displayed by the displaying unit 2610, acquire merged live streaming content and a question item, wherein the merged live streaming content is generated based on live streaming content of the first user account and live streaming content of a second user account.

The displaying unit 2610 is further configured to display the merged live streaming content and the question item, acquired by the acquiring unit 2620, on the live streaming interface.

The displaying unit 2610 is further configured to display an answering result of the question item on the live streaming interface.

In some embodiments, the acquiring units 2620 is further configured to, in response to receiving a trigger instruction for the entrance, acquire a plurality of candidate answers to the question item.

In some embodiments, the displaying unit 2610 is further configured to display the plurality of candidate answers when displaying the question item on the live streaming interface.

In some embodiments, the displaying unit 2610 is configured to perform at least one of the following steps:

displaying a user account, selecting a correct answer, in a corresponding display area of the correct answer in the plurality of candidate answers; and

displaying a user account, selecting a wrong answer, in a corresponding display area of the wrong answer in the plurality of candidate answers.

In some embodiments, the apparatus further includes a playing module.

The acquiring unit 2620 is further configured to acquire a question audio of the question item in response to receiving a trigger instruction for the entrance.

The playing module is configured to play the question audio when the question item is displayed on the live streaming interface.

In some embodiments, the displaying unit 2610 is further configured to display a first special effect on the live streaming interface in response to a correct answer of any user account to the question item. The first special effect is intended to indicate that the any user account acquires a virtual resource corresponding to the question item.

In some embodiments, the displaying unit 2610 is further configured to display a first answering party and a second answering party on the live streaming interface. The first answering party includes a user account teamed up with the first user account. The second answer team includes a user account teamed up with the second user account.

In some embodiments, the displaying unit 2610 is further configured to:

display a teaming reminder message on the live streaming interface, wherein the teaming reminder message is intended to prompt to join the first answering party or the second answering party; and

in response to receiving a user account joining message of a third user account, display the third user account in a corresponding display area of an answering party indicated by the user account joining message.

In some embodiments, the displaying unit 2610 is further configured to display a virtual resource of the first answering party and a virtual resource of the second answering party on the live streaming interface.

In some embodiments, the displaying unit 2610 is further configured to, in response to a correct answer of any user account to the question item, display a second special effect on the live streaming interface. The second special effect is intended to indicate that the any user account assists an answering party to which the any user account belongs with a virtual resource corresponding to the question item.

In some embodiments, the displaying unit 2610 is further configured to display, on the live streaming interface, at least one of ranking information of the first user account in a first user account set and ranking information of the second user account in a second user account set.

In some embodiments, the first user account set and the second user account set both include all user accounts answering the question within a preset time period. Alternatively, the first user account set includes user accounts on a relation chain corresponding to the first user account, and the second user account set includes user accounts on a relation chain corresponding to the second user account.

In some embodiments, the displaying unit 2610 is further configured to display an entrance for initiating the next round of answering in response to the end of this round of answering.

In some embodiments, the displaying unit 2610 is configured to execute at least one of the following steps:

displaying an answering invitation entrance for inviting the second user account to the next round of answering; and

displaying an answering initiation entrance for initiating the next round of answering with user accounts other than the second user account.

In the present embodiment, the entrance for initiating answering is provided on the live streaming interface, such that an anchor quickly initiates a joint live streaming with another anchor. Answering is performed during the joint live streaming. The answering result of the question item is displayed on the live streaming interface. Therefore, this answering process provides a new interaction mode to enable the two anchors to perform live streaming simultaneously and interact with each other, and also to enable audience in live streaming rooms of the two anchors to participate in the answering process, enhancing the interactivity in the live streaming rooms.

FIG. 27 is a block diagram of an apparatus for processing network data in accordance with an exemplary embodiment. Referring to FIG. 27, the apparatus includes a generating unit 2710 and a sending unit 2720.

The generating unit 2710 is configured to, in response to receiving answering requests from a first terminal and a second terminal, generate merged live streaming content based on live streaming content of a first user account logged on to the first terminal and live streaming content of a second user account logged on to the second terminal.

The sending unit 2720 is configured to send the merged live streaming content generated by the generating unit 2710 and a question item to the first terminal, the second terminal and a plurality of third terminals.

The sending unit 2720 is further configured to, in response to receiving an answer to the question item from any one of the first terminal, the second terminal and the plurality of third terminals, send an answering result of the question item to the first terminal, the second terminal and the plurality of third terminals.

In some embodiments, the apparatus further includes a first acquiring module, configured to perform any one of the following steps:

randomly selecting two user accounts as the first user account and the second user account from at least two user accounts initiating answering requests;

in response to the answering request of the first terminal, selecting one of the at least two user accounts initiating the answering requests as the second user account; and

in response to the answering request of the second terminal, selecting one of the at least two user accounts initiating the answering requests as the first user account.

In some embodiments, the apparatus further includes a second acquiring module, configured to assign the question item to the first user account and the second user account from a question item library.

In some embodiments, the sending unit 2720 is further configured to send a first answering party and a second answering party to the first terminal, the second terminal and the third terminals. The first answering party includes a user account teamed up with the first user account. The second answering party includes a user account teamed up with the second user account.

In some embodiments, the sending unit 2720 is further configured to execute at least one of the following steps:

sending a plurality of candidate answers to the question item to the first terminal, the second terminal and the plurality of third terminals; and

sending a question audio of the question item to the first terminal, the second terminal and the plurality of third terminals.

In the present embodiment, another anchor is assigned to an anchor initiating the answering request for a joint live streaming, and the question item is also assigned, such that the two anchors perform answering during the joint live streaming, audience in the live streaming rooms of the two anchors may participate in the answering process. The answering result of the question item is given after the participant users send the answer to the question item. Therefore, this answering process provides a new interaction mode to enable the two anchors to perform live streaming simultaneously and interact with each other, and also to enable the audience to participate in the answering process, enhancing the interactivity in the live streaming rooms.

With regard to the apparatus in the above embodiments, the specific manner in which the respective units perform the operations has been described in detail in embodiments of the method, and will not be explained in detail herein.

Other embodiments of the present disclosure will be apparent to those skilled in the art from consideration of the description and practice of the present disclosure disclosed herein. The present disclosure is intended to cover any variations, uses, or adaptations of the present disclosure following the general principles thereof and including such departures from the present disclosure as come within known or customary practice in the art. It is intended that the description and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the present disclosure only be subject to the appended claims.

What is claimed is:

1. A method for processing network data, the method being applicable to a first terminal, and comprising:
displaying a live streaming interface of a first user account logged on to the first terminal, the live streaming interface comprising an entrance for initiating answering;
in response to receiving a trigger instruction for the entrance, acquiring merged live streaming content and a question item, the merged live streaming content being generated based on live streaming content of the first user account and live streaming content of a second user account;
displaying the merged live streaming content and the question item on the live streaming interface; and
displaying an answering result of the question item on the live streaming interface.

2. The method according to claim 1, wherein after displaying the live streaming interface of the first user account logged on to the first terminal, the method further comprises:
in response to receiving a trigger instruction for the entrance, acquiring a plurality of candidate answers to the question item; and
displaying the plurality of candidate answers when displaying the question item on the live streaming interface.

3. The method according to claim 2, wherein displaying the answering result of the question item on the live streaming interface comprises any one of the following steps:
displaying a user account, selecting a correct answer, in a corresponding display area of the correct answer in the plurality of candidate answers; and
displaying a user account, selecting a wrong answer, in a corresponding display area of the wrong answer in the plurality of candidate answers.

4. The method according to claim 1, wherein after displaying the live streaming interface of the first user account logged on to the first terminal, the method further comprises:
in response to receiving a trigger instruction for the entrance, acquiring a question audio of the question item; and
playing the question audio when displaying the question item on the live streaming interface.

5. The method according to claim 1, wherein after acquiring the merged live streaming content and the question item, the method further comprises:
in response to a correct answer of any user account to the question item, displaying a first special effect on the live streaming interface, the first special effect being intended to indicate that the any user account acquires a virtual resource corresponding to the question item.

6. The method according to claim 1, wherein after receiving the trigger instruction for the entrance, the method further comprises:
displaying a first answering party and a second answering party on the live streaming interface, the first answering party comprising a user account teamed up with the first user account, the second answer team comprising a user account teamed up with the second user account.

7. The method according to claim 6, further comprising:
displaying a teaming reminder message on the live streaming interface, the teaming reminder message being intended to prompt to join the first answering party or the second answering party; and
in response to receiving a user account joining message of a third user account, displaying the third user account in a corresponding display area of an answering party indicated by the user account joining message.

8. The method according to claim 6, further comprising:
displaying a virtual resource of the first answering party and a virtual resource of the second answering party on the live streaming interface.

9. The method according to claim 8, further comprising:
in response to a correct answer of any user account to the question item, displaying a second special effect on the live streaming interface, the second special effect being intended to indicate that the any user account assists an answering party to which the any user account belongs with a virtual resource corresponding to the question item.

10. The method according to claim 8, further comprising:
displaying, on the live streaming interface, at least one of ranking information of the first user account in a first user account set and ranking information of the second user account in a second user account set.

11. The method according to claim 10, wherein the first user account set and the second user account set both comprise all user accounts answering the question within a preset time period; or
the first user account set comprises user accounts on a relation chain corresponding to the first user account and the second user account set comprises user accounts on a relation chain corresponding to the second user account.

12. The method according to claim 1, wherein after displaying the answering result of the question item on the live streaming interface, the method further comprises:
in response to the end of this round of answering, displaying an entrance for initiating a next round of answering.

13. The method according to claim 12, wherein displaying the entrance for initiating the next round of answering comprises at least one of the following steps:
displaying an answering invitation entrance for inviting the second user account to the next round of answering; and
displaying an answering initiation entrance for initiating the next round of answering with user accounts other than the second user account.

14. A method for processing network data, the method being applicable to a server, and comprising:
in response to receiving answering requests from a first terminal and a second terminal, generating merged live streaming content based on live streaming content of a first user account logged on to the first terminal and live streaming content of a second user account logged on to the second terminal;
sending the merged live streaming content and a question item to the first terminal, the second terminal and a plurality of third terminals; and
in response to receiving an answer to the question item from any one of the first terminal, the second terminal and the plurality of third terminals, sending an answering result of the question item to the first terminal, the second terminal and the plurality of third terminals.

15. The method according to claim 14, wherein before generating the merged live streaming content based on the live streaming content of the first user account logged on to the first terminal and the live streaming content of the second user account logged on to the second terminal, the method further comprises any one of the following steps:
randomly selecting two user accounts as the first user account and the second user account from at least two user accounts initiating the answering requests;
in response to the answering request from the first terminal, selecting one of the at least two user accounts initiating the answering requests as the second user account; and
in response to the answering request from the second terminal, selecting one of the at least two user accounts initiating the answering requests as the first user account.

16. The method according to claim 14, wherein before sending the merged live streaming content and the question item to the first terminal, the second terminal and the plurality of third terminals, the method further comprises:
assigning the question item to the first user account and the second user account from a question item library.

17. The method according to claim 14, wherein after receiving the answering requests from the first terminal and the second terminal, the method further comprises:
sending a first answering party and a second answering party to the first terminal, the second terminal and the third terminals, the first answering party comprising a user account teamed up with the first user account, the second answering party comprising a user account teamed up with the second user account.

18. The method according to claim 14, wherein after receiving the answering requests from the first terminal and the second terminal, the method further comprises at least one of the following steps:
sending a plurality of candidate answers to the question item to the first terminal, the second terminal and the plurality of third terminals; and
sending a question audio of the question item to the first terminal, the second terminal and the plurality of third terminals.

19. A terminal, comprising:
at least one processor;
at least one memory configured to store at least one instruction executable by the at least one processor;
wherein the at least one processor is configured to execute the at least one instruction to perform a method comprising:
displaying a live streaming interface of a first user account logged on to a first terminal, the live streaming interface comprising an entrance for initiating answering;
in response to receiving a trigger instruction for the entrance, acquiring merged live streaming content and a question item, the merged live streaming content being generated based on live streaming content of the first user account and live streaming content of a second user account;
displaying the merged live streaming content and the question item on the live streaming interface; and
displaying an answering result of the question item on the live streaming interface.

20. A server, comprising:
at least one processor;
at least one memory configured to store at least one instruction executable by the at least one processor;
wherein the at least one processor is configured to execute the at least one instruction to perform a method comprising:
in response to receiving answering requests from a first terminal and a second terminal, generating merged live streaming content based on live streaming content of a first user account logged on to the first terminal and live streaming content of a second user account logged on to the second terminal;
sending the merged live streaming content and a question item to the first terminal, the second terminal and a plurality of third terminals; and
in response to receiving an answer to the question item from any one of the first terminal, the second terminal and the plurality of third terminals, sending an answering result of the question item to the first terminal, the second terminal and the plurality of third terminals.

21. A non-transitory storage medium storing at least one instruction therein, wherein the at least one instruction, when executed by a processor of a terminal, enables the terminal to perform a method comprising:
displaying a live streaming interface of a first user account logged on to the first terminal, the live streaming interface comprising an entrance for initiating answering;
in response to receiving a trigger instruction for the entrance, acquiring merged live streaming content and a question item, the merged live streaming content being generated based on live streaming content of the first user account and live streaming content of a second user account;
displaying the merged live streaming content and the question item on the live streaming interface; and
displaying an answering result of the question item on the live streaming interface.

22. A non-transitory storage medium storing at least one instruction therein, wherein the at least one instruction, when executed by a processor of a server, enables the server to perform a method comprising:
in response to receiving answering requests from a first terminal and a second terminal, generating merged live streaming content based on live streaming content of a first user account logged on to the first terminal and live streaming content of a second user account logged on to the second terminal;
sending the merged live streaming content and a question item to the first terminal, the second terminal and a plurality of third terminals; and
in response to receiving an answer to the question item from any one of the first terminal, the second terminal and the plurality of third terminals, sending an answering result of the question item to the first terminal, the second terminal and the plurality of third terminals.
